(19) United States
(12) Patent Application Publication
(10) Pub. No.: US 2016/0041438 A1
(43) Pub. Date: Feb. 11, 2016

(54) ARRAY SUBSTRATE, DISPLAY DEVICE AND DRIVING METHOD THEREOF

(71) Applicants: BOE TECHNOLOGY GROUP CO., LTD, Beijing (CN); HEFEI BOE OPTOELECTRONICS TECHNOLOGY CO., LTD., Anhui (CN)

(72) Inventors: Zuquan HU, Beijing (CN); Ming HU, Beijing (CN)

(21) Appl. No.: 14/415,634

(22) PCT Filed: Apr. 25, 2014
(86) PCT No.: PCT/CN2014/076238

§ 371 Date: Jan. 19, 2015

(30) Foreign Application Priority Data
Dec. 27, 2013 (CN) 201310753325.2

(51) Int. Cl. G02F 1/1343; G02F 1/1333; G09G 3/36; G06F 3/041; G06F 3/044

(52) U.S. Cl. CPC G02F 1/134363; G06F 3/0412; G06F 3/044; G09G 3/3659; G02F 1/13338; G09G 2320/02

(57) ABSTRACT

The invention provides an array substrate, a display device and a driving method thereof. The array substrate comprises a plurality of gate lines and data lines, the gate lines and the data lines define a plurality of pixel units arranged in an array, each of which comprises a common electrode and a pixel electrode, wherein the common electrodes of at least part of the pixel units are formed as touch driving electrodes, at least part of the data lines are formed as touch sensing electrodes, wherein the touch driving electrodes and the touch sensing electrodes are insulated from each other; the touch driving electrodes are applied with common voltages during a display period, and are applied with touch scan signals during a touch period; and the touch sensing electrodes are applied with data signals during the display period, and generate and output coupling signals during the touch period.

### FIELD OF THE INVENTION

The invention relates to the field of liquid crystal display technology, and particular to an array substrate, a display device and a driving method thereof.

### BACKGROUND OF THE INVENTION

Liquid crystal display screens have been widely used in various display fields, such as family, public places, offices and personal electronic products etc. Generally, a liquid crystal display screen consists of a liquid crystal cell formed by aligning an array substrate and a color filter substrate, a polarizer and a backlight module etc. With the increase of people's demand on display, currently, the liquid crystal display screen with a touch screen has been more and more widely used, the touch screen typically includes a resistive, capacitive, optical, acoustic touch screen or the like, as an in-cell capacitive touch screen is formed by providing a touch sensing circuit in the cell, therefore the cell may be thinner and lighter compared to other touch screens, and thus the cost is decreased, and the touch screen with such a structure gets more and more attention.

FIG. 1 is a principle diagram of a common in-cell capacitive touch screen, it can be seen from the figure that, the touch screen is formed with a large number of metal wires crossing with each other in horizontal and vertical directions, wherein the metal wires in horizontal direction may be used as signal lines for transmitting sensing touch signals and indicated by T1, T2, T3 , . . . , TN respectively, and signal lines for receiving the sensing touch signals may be indicated by R1, R2, R3, . . . , RN respectively. When the touch screen is touched, a corresponding received signal is changed so that the location of the touch may be positioned, and then the touch may be processes by a touch unit.

However, in manufacturing the above in-cell capacitive touch screen, it is necessary to fabricate a large number of metal lines separately as signal lines for touch so that the process is complicated, and in the meanwhile, the aperture ratio of the display is decreased.

### SUMMARY OF THE INVENTION

In view of above problem, the present invention provides an array substrate, a display device and a driving method thereof, which can solve the above problem.

A solution to solve the above problem is an array substrate, which comprises a plurality of gate lines and a plurality of data lines, the gate lines and the data lines define a plurality of pixel units arranged in an array, each of which comprises a common electrode and a pixel electrode, wherein

the common electrodes of at least part of the pixel units are formed as touch driving electrodes, at least part of the data lines are formed as touch sensing electrodes, and the touch driving electrodes and the touch sensing electrodes are insulated from each other;

the touch driving electrodes are applied with common voltages during a display period, and are applied with touch scan signals during a touch period; and

the touch sensing electrodes are applied with data signals during the display period, and generate and output coupling signals during the touch period.

In the array substrate in the invention, in the display period, data signals are applied to data lines, at this time, the pixel electrodes are driven by the data lines, that is to say, the touch sensing electrodes are applied with data signals during the display period. Meanwhile, common voltages are applied, in the display period, to the common electrodes, wherein the common electrodes maintain a uniform common voltage, and at this time, the touch driving electrodes are applied with the common voltages. In the touch period, the touch driving electrodes are applied with touch scan signals, the touch sensing electrodes generate and output coupling signals to a judging unit, then the judging unit determines the location of the touch point based on the coupling signals output from the touch sensing electrodes so as to achieve a touch display.

Preferably, the common electrodes of the pixel units in every two to six rows are connected as one touch driving electrode.

Preferably, the touch driving electrodes are connected in a row direction or a column direction of the pixel units.

Preferably, the array substrate further comprises common electrode lines, and the touch driving electrodes are connected in the row direction or the column direction of the pixel units through the common electrode lines.

Preferably, the pixel electrode is provided above the common electrode, and is a slit-shaped electrode.

Preferably, both of the pixel electrode and the common electrode are slit-shaped electrodes.

Preferably, each of the pixel units comprises a thin film transistor, a gate of which is connected to the gate line, a source of which is connected to the data line, and a drain of which is connected to the pixel electrode.

A solution to solve the above problem is a display device comprising the above array substrate.

Since the display device in the invention comprises the above array substrate, it can achieve the touch function.

A solution to solve the above problem is a driving method of a display device, comprising:

dividing a time period for displaying one frame by the display device into a display period and a touch period, wherein the display device comprises an array substrate, the array substrate comprises a plurality of gate lines and a plurality of data lines, the gate lines and the data lines define a plurality of pixel units arranged in an array, each of which comprises a common electrode and a pixel electrode, the common electrodes of at least part of the pixel units are formed as touch driving electrodes, and at least part of the data lines are formed as touch sensing electrodes,

in the display period, sequentially applying gate scan signals to the plurality of gate lines, applying data signals to the plurality of data lines, and applying common voltage signals to the common electrodes; and

in the touch period, applying touch scan signals to the touch driving electrodes, the touch sensing electrodes couple the touch scan signals and output coupling signals, and no signal is inputted into the plurality of gate lines.

### BRIEF DESCRIPTION OF THE DRAWINGS

FIG. 1 is a principle diagram for realizing touch function in the prior art;

FIG. 2 is structural diagram of an array substrate in embodiment 1 of the invention; and

FIG. 3 is a timing chart of a driving method of a display device in embodiment 3 of the invention.

### Reference Signs

1. common electrode line; 2. data line; 3. gate line; 4. thin film transistor; 5. common electrode; and 6. pixel electrode.

### DETAILED DESCRIPTION OF EMBODIMENTS

In order to make a person skilled in the art understand the solution of the invention better, the invention will be described in detail below in conjunction with drawings and embodiments.

### Embodiment 1

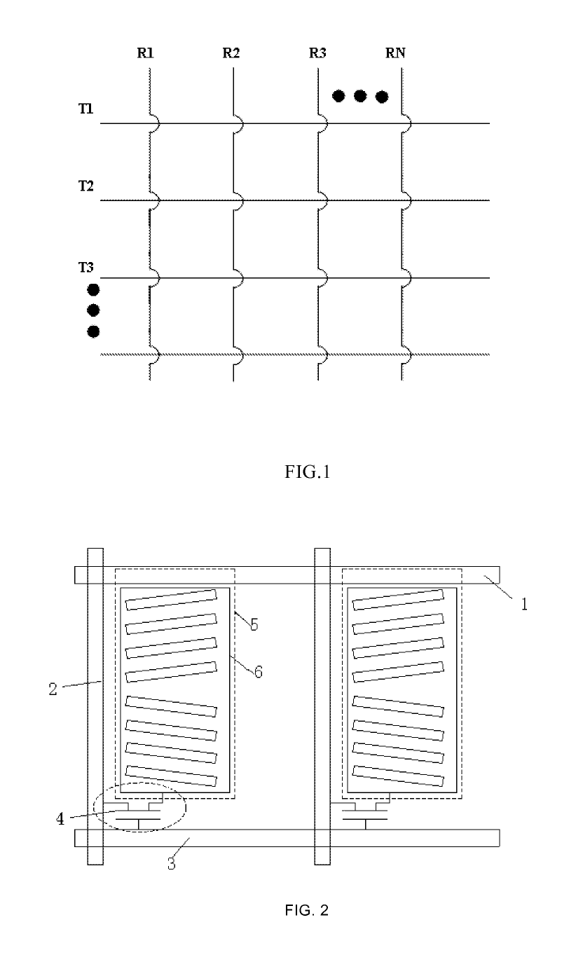

As shown in FIG. 2, this embodiment provides an array substrate comprising a plurality of pixel units arranged in an array and defined by a plurality of gate lines 3 and a plurality of data lines 2, and each of the pixel units comprises a common electrode 5 and a pixel electrode 6. The common electrodes of at least part of the pixel units are formed as touch driving electrodes, at least part of the data lines 2 are formed as touch sensing electrodes, and the touch driving electrodes and the touch sensing electrodes are insulated from each other. It should be noted that, in order to facilitate the description, only one gate line 3 and one data line 2 are shown in FIG. 2, but the numbers of the gate lines and the data lines are not limited thereto.

The touch driving electrodes are applied with a common voltage during a display period, and are applied with touch scan signals during a touch period; and

the touch sensing electrodes are applied with data signals during the display period, and couple the touch scan signals and output coupling signals during the touch period.

In the array substrate of the embodiment, during the display period, the data line 2 is applied with a data signal, and the pixel electrode is applied with the data signal through the data line 2; at the same time, during the display period, the common electrodes 5 are applied with common voltages and the common electrodes 5 maintain a uniform common voltage. During the touch period, part or all of the common electrodes 5 function as touch driving electrodes, which are applied with touch scan signals, and other common electrodes 5 which do not function as touch driving electrodes are not applied with signals, at this time the touch sensing electrodes couple the touch scan signals and output them to a judging unit, then the judging unit determines a location of the touching point according to the signals coupled by the touch sensing electrodes, so that a touching function may be achieved.

In realizing the touch function, common electrodes 5 of the pixel units in each row may be connected to function as a touch driving electrode during the touch period, alternatively, common electrodes 5 of the pixel units in a plurality of rows may be connected to function as a touch driving electrode during the touch period. In order to simplify the touch driving without decreasing the touch accuracy, preferably, the common electrodes 5 of the pixel units in adjacent two to six rows are connected as a touch driving electrode.

In order to simplify the wiring and save cost, preferably, the touch driving electrodes are connected in a row direction or a column direction of the pixel units.

Preferably, the array substrate further comprises common electrode lines 1, and the touch driving electrodes are connected in the row direction or the column direction of the pixel units through the common electrode lines 1. Of course, the common electrodes 5 are not limited to be connected through the common electrode lines 1, it is possible to use other metal wires. Alternatively, it is also possible to connect the common electrodes 5 of adjacent pixel units using the same material as the common electrodes 5 to form the touch driving electrodes when the common electrodes 5 are manufactured.

Preferably, the array substrate may be of ADS mode. At this time, the pixel electrode 6 is provided above the common electrode 5 and is a slit-shaped electrode, the common electrode 5 is a plate-shaped electrode, the pixel electrode 6 and the common electrode 5 are separated from each other through an insulating planarization layer. Of course, it is also possible to provide the common electrode 5 above the pixel electrode 6, at this time, the common electrode 5 is a slit-shaped electrode, and the pixel electrode 6 is a plate-shaped electrode. Of course, both of the pixel electrode 6 and the common electrode 5 may be slit-shaped electrodes and are provided to be insulated from each other, wherein the positions of the pixel electrode 6 and the common electrode 5 may be exchanged.

Preferably, both of the pixel electrode 6 and the common electrode 5 may be slit-shaped electrodes, and are provided in the same layer and insulated from each other, and at this time, the array substrate is of IPS mode.

It should be noted that, this embodiment is not limited to the array substrate of ADS and IPS modes. The common electrodes and the pixel electrodes may be made of Indium gallium zinc oxide (IGZO), Indium zinc oxide (IZO), indium tin oxide (InSnO), indium gallium tin oxide (InGaSnO) or the like, and furthermore, they may be made of other transparent conductive materials.

Preferably, the pixel unit further comprises a thin film transistor 4, a gate of which is connected to the gate line 3, a source of which is connected to the data line 2, and a drain of which is connected to the pixel electrode 6. When the gate line 3 is at a high level, the thin film transistor 4 is turned on, the data line 2 is connected to the pixel electrode through the thin film transistor 4 to write a pixel voltage into the pixel electrode 6, and the common electrode 5 is applied with a common voltage signal. When the gate line 3 is at a low level, the thin film transistor 4 is turned off, electrode bars in the common electrodes 5 functioning as touch driving electrodes are applied with touch scan signals, specifically, the driving signal may be transferred through the common electrode line 1.

In the array substrate in the embodiment, at least part of the common electrodes 5 are used as touch driving electrodes, and at least part of the data lines 2 are used as touch sensing electrodes. When a touch occurs, the coupling capacitance between the touch driving electrode and the touch sensing electrode is changed, resulting in change in a coupling signal output from the touch sensing electrode, so that a position touched may be determined. A display panel may have touch display function by applying the array substrate to the display panel.

### Embodiment 2

This embodiment provides a display device comprising the array substrate in the embodiment 1. The display device may be: any product or component with a display function, such as a mobile phone, a tablet computer, a television, a display, a notebook computer, a digital photo frame and a navigator.

Since the display device of the embodiment has the array substrate in embodiment 1, it can have a touch function.

Of course, the display device of the embodiment may also comprise other conventional structures, such as a power supply unit, a display driving unit etc.

### Embodiment 3

The embodiment provides a driving method of a display device, which comprises:

dividing a time period for displaying one frame by the display device into a display period and a touch period, wherein the display device comprises an array substrate, the array substrate comprises a plurality of gate lines 3 and a plurality of data lines 2, the gate lines 3 and the data lines 2 define a plurality of pixel units arranged in an array, each of which comprises a common electrode 5 and a pixel electrode 6, the common electrodes 5 comprise touch driving electrodes, and the data lines 2 comprise touch sensing electrodes. It should be noted that, in order to facilitate the description, FIG. 2 only shows a gate line 3 and a data line 2, but numbers thereof are not limited thereto.

In the display period, sequentially applying gate scan signals to the plurality of gate lines 3, applying data signals to the plurality of data lines 2, and applying common voltage signals to the common electrodes 5, so that the pixel units are driven to display.

In the touch period, applying touch scan signals to the touch driving electrodes, the touch sensing electrodes couple the touch scan signals and output coupling signals, and no signal is inputted into a controller from the gate lines 3, then the controller may determine the touch coordinates according to changes in amount of charges, so that touch display may be realized.

In order to understand the display method of the embodiment better, an example will be described below.

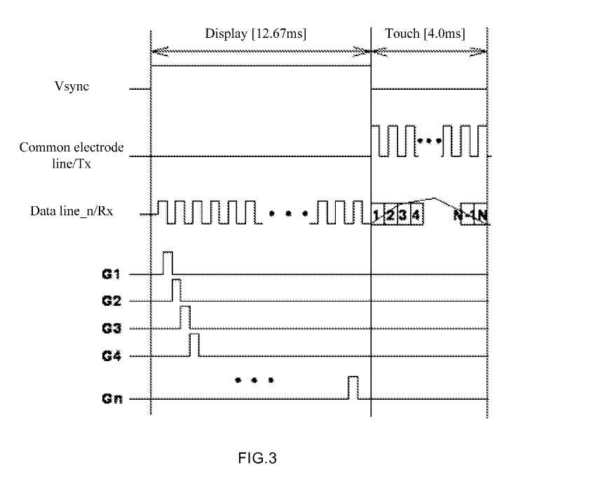

FIG. 3 shows an operation timing chart of the above display device, and as shown in FIG. 3, the display device operates in a time-division manner. FIG. 3 shows an operation process of the display device in an operation period for a frame of image (for example, a refresh frequency is 60 Hz), wherein whether the display device is in a display period or a touch period is controlled by a signal (Vsync) applied to the gate line 3. In FIG. 3, in the prior 12.67 ms, the Vsync is at a high level, and the display is in the display period, and in the later 4 ms, the Vsync is at a low level, and the display is in the touch period. During the display period, the gate lines 3 control TFTs row-by-row to turn on, as shown by G1, G2, G3, . . . , Gn in FIG. 3, at this time, data signals for a corresponding picture are written into the data lines 2, meanwhile, uniform common voltage signals are inputted into the common electrode lines 1 through the driving unit, so that all of the common electrodes 5 maintain a certain voltage (signals on the common electrodes 5 and signals applied to the common electrode lines 1 are the same), then the display device displays normally. During the touch period, the gate lines 3 are all at a low level, then all the switch units (for example, thin film transistors 4) are turned off, electric charges are maintained in the pixels, part or all of the common electrodes 5 functioning as the touch driving electrodes are applied with touch scan signals, at this time, part or all of the data lines 2 functioning as the touch sensing electrodes generate and output coupling signals, when a touch occurs, the coupling signal output from the touch sensing electrode is changed, so that the touched position may be determined.

It should be understood that, the above embodiments are described only to illustrate the principle of the invention, and the invention is not limited thereto. Persons skilled in the art can make various modifications and improvements without departing from the principle and substance of the invention, and these modifications and improvements should be considered to be within the protection scope of the invention.

1-9. (canceled)

10. An array substrate comprising a plurality of gate lines and a plurality of data lines, the gate lines and the data lines define a plurality of pixel units arranged in an array, each of which comprises a common electrode and a pixel electrode, wherein
the common electrodes of at least part of the pixel units are formed as touch driving electrodes, at least part of the data lines are formed as touch sensing electrodes, and the touch driving electrodes and the touch sensing electrodes are insulated from each other;
the touch driving electrodes are applied with common voltages during a display period, and are applied with touch scan signals during a touch period; and
the touch sensing electrodes are applied with data signals during the display period, and generate and output coupling signals during the touch period.

11. The array substrate of claim 10, wherein the common electrodes of the pixel units in every two to six rows are connected as a touch driving electrode.

12. The array substrate of claim 10, wherein the touch driving electrodes are connected in a row direction or a column direction of the pixel units.

13. The array substrate of claim 10, further comprises common electrode lines, wherein the touch driving electrodes are connected in the row direction or the column direction of the pixel units through the common electrode lines.

14. The array substrate of claim 10, wherein the pixel electrode is provided above the common electrode, and is a slit-shaped electrode.

15. The array substrate of claim 11, wherein the pixel electrode is provided above the common electrode, and is a slit-shaped electrode.

16. The array substrate of claim 12, wherein the pixel electrode is provided above the common electrode, and is a slit-shaped electrode.

17. The array substrate of claim 13, wherein the pixel electrode is provided above the common electrode, and is a slit-shaped electrode.

18. The array substrate of claim 10, wherein both of the pixel electrode and the common electrode are slit-shaped electrodes.

19. The array substrate of claim 11, wherein both of the pixel electrode and the common electrode are slit-shaped electrodes.

20. The array substrate of claim 12, wherein both of the pixel electrode and the common electrode are slit-shaped electrodes.

21. The array substrate of claim 13, wherein both of the pixel electrode and the common electrode are slit-shaped electrodes.

22. The array substrate of claim 10, wherein each of the pixel units comprises a thin film transistor, a gate of which is connected to the gate line, a source of which is connected to the data line, and a drain of which is connected to the pixel electrode.

23. A display device comprising the array substrate of claim 10.

24. A driving method of a display device, comprising:
dividing a time period for displaying one frame by the display device into a display period and a touch period, wherein the display device comprises an array substrate, the array substrate comprises a plurality of gate lines and a plurality of data lines, the gate lines and the data lines define a plurality of pixel units arranged in an array, each of which comprises a common electrode and a pixel electrode, the common electrodes of at least part of the pixel units are formed as touch driving electrodes, and at least part of the data lines are formed as touch sensing electrodes,
in the display period, sequentially applying gate scan signals to the plurality of gate lines, applying data signals to the plurality of data lines, and applying common voltage signals to the common electrodes; and
in the touch period, applying touch scan signals to the touch driving electrodes, and coupling the touch scan signals and outputting coupling signals by the touch sensing electrodes, wherein no signal is inputted into the plurality of gate lines.
